(19) United States
(12) Patent Application Publication
(10) Pub. No.: US 2026/0197248 A1
(43) Pub. Date: Jul. 9, 2026

(54) 5G NETWORK ARCHITECTURE FOR PROCESSING LLM INFERENCE PROCESS REQUESTS IMPLEMENTING KEY-VALUE CACHES

(71) Applicant: ILIAD, Paris (FR)

(72) Inventors: Khaled Sayad, Paris (FR); Patrick Escande, Paris (FR)

(21) Appl. No.: 19/305,432

(22) Filed: Aug. 20, 2025

(30) Foreign Application Priority Data
Jan. 8, 2025 (EP) 25315007.2

(51) Int. Cl. H04L 41/16; H04L 45/02; H04W 28/02; H04W 28/16

(52) U.S. Cl. CPC H04L 41/16; H04L 45/08; H04W 28/0268; H04W 28/16

(57) ABSTRACT

This architecture comprises a 5G network according to 3GPP, with a peer-to-peer network of gNBs including far-edge server calculation and storage resources, a user plane/data plane network, and a core network control plane. The LLM applications implement multi-layer regressive inference processes using key-value caches allocated to respective user equipments, UEs. These key-value caches are ephemeral caches with a limited lifetime, and are stored in a distributed manner within the 5G network in the calculation and storage resources of the gNBs serving the UEs. A cache scheduler interacts with the LLM applications and with the gNBs via the core network control plane to create the key-value caches, assign the created key-value caches to the respective UEs, determine the lifetime of the key-value caches created, and update the key-value caches, in particular by a P2P process between the gNBs in accordance with a management plane defined by the cache scheduler.

The invention relates to fifth generation (5G) mobile cellular networks, in particular an architecture specifically adapted to processing interactions between user equipments (UEs) and resources associated with Large Language Models (LLMs).

In the present disclosure, the term “users” refers not only to physical persons connected to the 5G network using a smartphone as a UE, but also—and above all—to autonomous hardware devices such as, for example, robots, surveillance cameras or piloted vehicles, connected to the 5G cellular network and whose profile has already been entered in a user database of the 5G core network. In the same way, the term “request” includes any type of message likely to be generated for an LLM by such “users”, whether the latter are natural persons or, fully automatically, by machine “users” such as Automated Guided Vehicles (AGVs), industrial robots or any other device or equipment operating in an IoT (Internet of Things) environment.

### TECHNICAL FIELD OF THE INVENTION

These users are liable to send to LLM applications requests that may be produced in very large amounts and at relatively high rates, in particular in the case of autonomous hardware devices, such as above-mentioned AGVs, industrial robots or IoT devices.

An LLM application operates by running a pre-trained model to process the tokens (within the meaning of Artificial Intelligence) of the requests sent by the users, and to generate the corresponding outputs.

The invention is particularly aimed at LLM applications implementing multi-layer autoregressive inference processes, such as in particular “transformers” models.

In these processes, for each token that is being processed, the model generates a key “K” and a value “V” of a vector resulting from the processing of this request by the LLM model. The key K is generally a hash resulting from an encoding of either the token introduced by the user in the request thereof, or results of intermediate input tokens of the autoregressive process.

In order for the model to generate new output tokens to be processed by the next layer of the autoregressive process, it is necessary to temporarily store the {key; value}, {K; V}, structure in a data register called “key-value cache” or “KV cache”. This cache is used to store the context of the preceding tokens of the autoregressive process so that the model can predict the following tokens of the sequence.

For example, the article by Guanqiao et al. “Mobile Edge Intelligence for Large Language Models: A Contemporary Survey”, IEEE Communications Surveys & Tutorials, 2025, arXiv:2407.18921v1 [cs.NI] 9 Jul. 2024, describes the implementation of such KV caches in network devices located at the edge level with various optimization techniques, e.g. by dynamic size reduction of the KV caches.

### STATE OF THE ART

The invention is specifically aimed at the management of such caches in the particular context of LLM requests from users of a 5G-type mobile network.

In this context, the article by Zhao et al. “Adaptive Partitioning and Placement for Two-Layer Collaborative Caching in Mobile Edge Computing Networks,” IEEE Transactions on Wireless Communications, Vol. 23, no. 8, 3 Jan. 2024, pp. 8215-8231, proposes to split the contents of caches on edge servers into private and public caches, based on the similarity of caches in the same group of gNBs in a 5G network.

In the following of the description, for the sake of simplification, only the “KV cache” term will be used, but it is obvious that this term has to be understood in its specific restricted sense of {key; value} data structure of an autoregressive LLM inference process as exposed hereinabove, and not in its current broad sense of simply temporary or intermediate memory. Moreover, the “KV cache” term will be used here to designate the memory location storing the {key; value} data structure (i.e. to designate the container) and not the key and the value stored at this location (the cognitive content).

A first problem linked to the use of KV caches is the memory size required. The latter is very high and increases with the number of tokens processed, with the sizes of the K and V vectors, and with the number of layers of the LLM model. Memory sizes of several gigabytes can thus be found in the most powerful models.

There are two possible approaches: either the KV caches are stored in the HBM (High Bandwidth Memory) integrated to the chip of the GPUs used by the LLM model, or they are stored in a high-capacity external memory. In the first case, the access to the KV cache is extremely fast (with a bandwidth of several hundred gigabytes per second), but at the cost of a limited storage capacity; in the second case, the capacity limitation is no longer a problem, but the trade-off is a significant slowdown in request processing due to smaller bandwidth. It might be possible to provide for differentiated storage of the KV caches, by keeping the active KV caches in HBM and by moving the inactive KV caches to an external memory, but this only partially solves the difficulty, and at the cost of complex memory management.

A second problem lies in the fact that the requests are processed individually by the model, even if some of the calculations have already been performed, for the same user or for other users.

In fact, in order to limit the number of tokens and KV caches, it would be desirable to be able to reuse the results of calculations already carried out in a similar context.

In particular, from the point of view of the mobile network access provider, the transfer of packets of redundant or very similar LLM requests to the servers hosting the LLM applications results in unnecessary consumption of resources, with negative consequences on the LLM process performance as a result of longer queues, increased request processing times, and increased load on servers hosting the LLM applications.

Moreover, when the LLM requests are associated with tokens that are subject to a charge or a quota (for example, a quota for each department of a company), it is important to limit the use thereof, bearing in mind that any redundant request will unnecessarily lead to the consumption of one token.

A third problem lies in that, from the user's point of view, the just-exposed limitations have in any case for effect to increase the latency of the LLM request, i.e. the time delay between submitting the request and receiving the generated output expected by the user. This reactivity of the LLM model can in particular be evaluated by the TTFT (Time To First Token) performance metric, which is a particularly critical parameter in the case of users that are autonomous hardware devices such as industrial robots or piloted vehicles.

### DISCLOSURE OF THE INVENTION

The object of the invention is to remedy all these drawbacks and limitations, by proposing a 5G mobile network architecture specifically adapted and optimized for processing LLM requests implementing KV caches, with an optimum sharing of the storage resources allocated to the KV caches and, subsidiarily, taking into account any potential similarities of requests addressed to the LLM application, in particular requests from users that reconnect successively to the network to send a same type of request, or between users of similar profiles within a same access network.

For that purpose, the invention proposes an architecture for processing LLM requests addressed to LLM applications implementing multi-layer regressive inference processes using key-value caches allocated to respective UEs. The architecture comprises, in a manner known per se, a 5G network with: a radio access network, for radiofrequency communication with user equipments, UEs, the UEs accessing the network via 5G access nodes according to 3GPP, gNBs, including far-edge server calculation and storage resources; a distributed network of programmable user plane functions, UPFs, also acting as a 5G data transport plane for routing data packets towards/from the UEs; and a core network control plane comprising 5G functions according to 3GPP. For processing LLM requests, the LLM applications implement multi-layer regressive inference processes using key-value caches allocated to respective UEs.

Characteristically of the invention, the calculation and storage resources of the gNBs are configured to form a peer-to-peer network implementing key-value caches distributed within the 5G network, adapted to store LLM requests from the UEs, wherein the gNBs serve the respective UEs. The key-value caches are ephemeral caches with a limited lifetime, and the architecture further comprises a cache scheduler adapted to interact, on the one hand, with the LLM applications and, on the other hand, with the gNBs via the core network control plane, this cache scheduler comprising means adapted to create the key-value caches, assign the created key-value caches to the respective UEs, determine the lifetime of the key-value caches created, and update the key-value caches.

According to various subsidiary advantageous features:
the cache scheduler is adapted to establish a concatenation scheme for a plurality of existing key-value caches into a single merged key-value cache, allocated to a plurality of UEs;
point-to-point, P2P, communication means are provided between gNBs to execute within the radio access network the concatenation of the plurality of existing key-value caches into a single merged key-value cache, according to the concatenation scheme established by the cache scheduler;
the cache scheduler is adapted, previously to the merging of the plurality of key-value caches, to determine, among a plurality of gNBs of the radio access network, a gNB determined as being optimum based on latency, capacity and/or bandwidth constraints, and to store the merged key-value cache at the so-determined gNB;
the cache scheduler is adapted, after completion of the LLM request processing and in the absence of subsequent LLM request, to suppress the merged key-value cache, assign unitary key-value caches to the UEs of the merged cache, and determine respective lifetimes for each of these unitary key-value caches;
the lifetime of each key-value cache is a lifetime calculated at the creation of the key-value cache by the cache scheduler based on metrics determined by the 5G network;
the cache scheduler is adapted to automatically clear the key-value caches after expiry of the limited lifetime;
the cache scheduler is adapted to assign an increased lifetime to the most frequently accessed key-value caches;
the lifetime calculation metrics include 5G network operational metrics, comprising: rate of use of the gNBs; storage capacity available in the gNBs; distribution/allocation of the network resources between uplink and downlink; latency; bandwidth; and/or maximum number of tokens per second;
the lifetime calculation metrics include metrics specific to the key-value cache user, comprising: frequency of use of the LLM applications by the user; belonging of the user to a predefined domain gathering a plurality of users; privilege level assigned to user; QoS degree guaranteed to the user; and/or subscription by the user to LLM inference services;
the lifetime calculation metrics include metrics of similarity between simultaneous users of the key-value caches, comprising: belonging or not to a same predefined domain grouping a plurality of users; and/or identical or close geographic location of the users;
point-to-point communication means are provided between gNBs for the direct exchange of information relating to the lifetime calculation metrics;
the UEs are devices of the group comprising smartphones, autonomous robots, and/or video surveillance cameras, including a circuit for connection to the 5G network and whose profile has already been entered into a user database of the 5G network core-network.

### BRIEF DESCRIPTION OF THE DRAWINGS

FIG. 1 is an overview, in the form of a block diagram, of the various functional elements of the architecture according to the invention for the processing of KV caches by a 5G network.

FIG. 2 illustrates the way to manage the different KV caches over time to optimize the resources available in the network as a function of the effective user of the KV caches.

FIG. 3 is a flow diagram illustrating the initiation of the KV caches management process according to the invention.

FIG. 4 is a flow diagram illustrating the completion of the KV caches management process according to the invention and updating of the distribution of these KV caches within the network.

### DETAILED DESCRIPTION OF EMBODIMENTS OF THE INVENTION

An example of implementation of the invention will now be described, with reference to the attached drawings in which the same references designate identical or functionally similar elements throughout the figures.

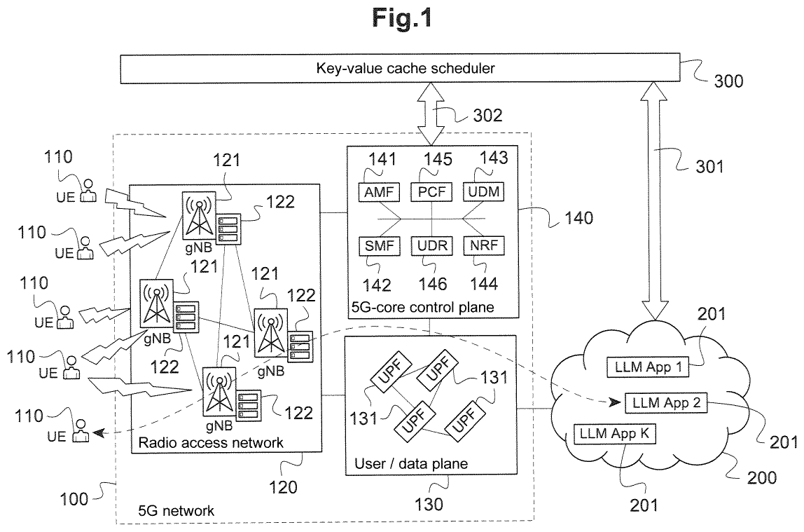

In FIG. 1, reference 100 designates the main components, known per se, of a 5G mobile network, this term being understood in the specific sense as defined by the standardization bodies, in particular 3GPP. It will be the same for the different components of this 5G network mentioned in the present disclosure, such as “radio access network”, “gNB”, “transport plane/data plane”, “UPF”, “control plane”, “5G-core”, “AMF”, “SMF”, “NRF”, “PCF”, etc., which must be understood in their specific sense, as understood by a person skilled in the art of mobile communication networks.

Reference 110 denotes user equipments, UEs, used to wirelessly exchange information with the 5G network.

As mentioned hereinabove, these users can be both physical persons and purely hardware-based autonomous equipment such as robots, cameras or vehicles, whose profile has already been entered into the 5G network.

5G network 100 comprises a part of radio access network 120 with a number of base stations 121 such as gNBs (in the 5G network nomenclature), or other comparable type of network nodes, for example of the “small cell” type. Hereinafter, reference will only be made to “gNBs”, but this term has to be understood as also including any type of functionally equivalent node for implementing the invention.

Specific calculation and storage resources 122 are associated with each gNB 121, collocated with the gNB and forming a local far-edge server datacenter located as close as possible to users connected to the access network 120.

The radio access network 120 is interfaced to a distributed network 130 of user plane functions, UPFs, 131, the user plane also acting as a data transport plane for routing data packets to and from the UEs 110.

The user plane/data plane 130 is interfaced to a core network control plane 140 (5G-core) including the following functions and resources:
AMF 141: Access and Mobility-management Function;
SMF 142: Session-Management Function, a function that, in association with AMF, is in charge of initiating the PDU sessions of the UEs 110. It controls the UPFs 131 of the user plane by programming them so as to establish, for each UE, the routing between, on the one hand, the gNB 121 to which the UE 110 is connected, and on the other hand, the data networks outside the 5G network. It is also in charge of creating, at the control plane, the link of each UE connected to the network with the LLM applications to which the requests issued by the users are addressed;
UDM 143: User-Data Management;
NRF 144: Network-function Repository Function, which is a function register with which all the 5G function instances register so that they can be discovered (service discovery) by the other 5G functions. It also registers, for the various LLM application instances, the specific domains served (this notion of “domain”, understood in the sense of a company department, will be developed hereinafter), with the corresponding range of the IP addresses of the UEs to be served;
PCF 145: Policy-Control Function;
UDR 146: User-Data Repository, this repository storing in particular the identity and profile of the different known UEs of the network.

Characteristically of the invention, the KV caches necessary of the LLM applications inference process are not stored at a remote server (such as server 200 hosting the LLM applications 201); they are stored at the gNB 121, in particular the calculation and storing resources 122. Insofar as the KV caches are specifically allocated to respective users, that is the gNB to which the user in question is connected that stores the KV cache allocated to this user.

Further, the KV caches located at the gNBs are ephemeral KV caches having a limited lifetime, with a TTL (Time To Live) of predetermined duration allocated to each KV cache.

Also characteristically of the invention, a KV cache scheduler 300 is provided, which is interfaced, on the one hand, in 301, to the server storing the LLM applications 201, and on the other hand, in 302, to the 5G network 100, via the control plane 140.

The scheduler 300 has access, via the control plane 140, to information on all the KV caches stored in the gNB of the radio access network 120, in particular their geographical distribution between the various gNB; this distribution will thereafter be called “KV cache distribution status”.

The scheduler 300 has also access, still via the control plane 140, to information about the users and their profiles, such as:
frequency of use of the LLM applications by the user;
belonging of the user to a predefined domain gathering a plurality of users;
privilege level assigned to user;
QoS degree guaranteed to the user; and/or
subscription by the user to LLM inference services.

The scheduler 300 has also access, still via the control plane 140, to information about the 5G network resources needs/availabilities, based on operational metrics such as:
rate of use of the gNB;
storage capacity available in the gNBs;
distribution/allocation of the network resources between uplink and downlink;
latency;
bandwidth; and/or
maximum number of tokens per second.

To automatically obtain these parameters, the continuous monitoring of the 5G network advantageously implements algorithms of the machine learning type operating based on a knowledge base that has been built up in advance and is constantly updated.

The scheduler 300 has in particular for role, as will be detailed hereinafter, to:
collect the metrics specific to the users and the operational metrics of the 5G network indicated hereinabove;
build KV caches allocated to the different users connected to the 5G network, and calculate their respective lifetime (TTL);
manage the distribution of the KV caches, i.e. the definition of their distribution between the different gNB; and
optimizing the KV caches to avoid redundancies between similar uses, to clear the KV caches that are no longer used, etc.

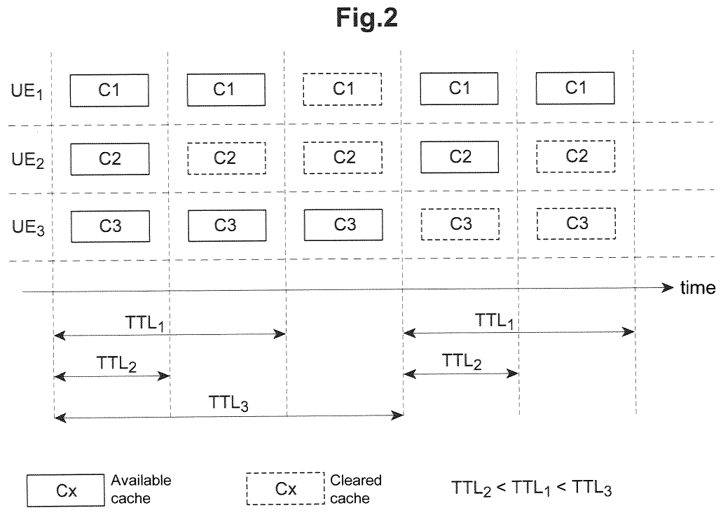

FIG. 2 illustrates the way the KV caches are managed, with, in this example, three KV caches C1, C2 and C3, having corresponding lifetimes TTL1, TTL2 and TTL3, allocated to the respective UEs UE1, UE2 and UE3. In this example, the lifetimes are different, with TTL1=2 time periods, TTL2=1 time period and TTL3=3 time periods. The time period chosen is not critical, it is only defined (i) long enough for the KV cache management not to be invasive for the network (no risk of overload, slowdown, additional resource requirements, etc.), and (ii) short enough for the updating of the KV cache distribution to have a noticeable effect on quality of service for the requests issued by the users: lower latency, better responsiveness (better TTFT), etc. In this respect, an hourly update of the KV cache distribution seems to be a satisfactory compromise in most cases currently encountered.

Initially, three KV caches C1, C2 and C3 coexist, for the three users UE1, UE2 and UE3. At t=TTL2 (the shortest TTL), if, for example, UE2 has become inactive, then its KV cache can be cleared in order to release storage resources in the gNB to which it is connected.

In the following period t=TTL1 (corresponding to lifetime expiry of the KV cache C1 allocated to UE1), if UE1 has became inactive, its KV cache C1 can also be cleared.

In the following period t=TTL3 (corresponding to lifetime expiry of the KV cache C3 allocated to UE3), UE3 having became inactive, is KV cache C3 is cleared; but as, in this example, an activity is again seen from UE1 and UE2, for each of these users, a corresponding KV cache C1 and C2 is recreated at the gNB(s) to which are connected UE1 and UE2, with the same respective lifetime TTL1 and TTL2 as previously, and so on for the following periods.

A dynamic clearing of the KF caches non used in the network has thus been operated, this operation being modulated depending on the greater or lesser degree of persistence TTL assigned to the different KF caches.

As regards the lifetime TTL assigned to the different KV caches, it is advantageously adapted so as to give a longer lifetime to the KV caches the most frequently accessed by the users, and vice versa, in order to optimize the operation of dynamic clearing of the KV caches at regular intervals.

In an advantageous implementation, the invention also proposes to merge a plurality of KV caches existing at a given time instant into a single merged KV cache, allocated in common to a plurality of UEs. This technique can be applied in particular to the specific situation in which several users having comparable profiles generate concomitantly identical or similar requests.

It may be in particular a group of users belonging to a same “domain”, this term being understood as a group of users corresponding, for example, to the same department among several departments of the same company (production, marketing, accounting, etc.), the users of the same group being likely to issue identical or comparable requests, different from those of another domain of their same company.

These “domains” can be discriminated as a function of the session IP address assigned to the user by the control plane 140, specifically by the SMF 142, wherein this information can be communicated by the 5G network to the scheduler 300 from the control plane 140.

As an alternative or a complement, the discrimination between groups of UE can also be based on the different privilege levels assigned to UEs, with higher privilege users, for example, having a higher quota of tokens authorized for issuing LLM requests. Longer-lifetime KV caches are then allocated to users with higher privileges than others.

In such cases, it can then be advantageous, in particular to increase the responsiveness to LLM requests (lower TTFT), to merge the plurality of KV caches assigned to the different users of comparable profile into a same concatenated KV cache, of greater size but unique and common to these users.

Before merging the KV caches, the scheduler 300 ensures that, among the plurality of gNBs accessed by the users concerned, one of these gNBs is determined to be optimum based on certain QoS constraints, in particular latency, capacity and/or bandwidth constraints, the merged KV cache being then located at a reserved memory location on the gNB considered optimum.

The concatenation can be in particular carried out by a direct peer-to-peer (P2P) communication process between the different gNB concerned, so as to communicate horizontally (i.e. from gNB to gNB within the access network 120 itself, for example via an Xn interface) to the gNB designated as being optimum the information and data of the other peer gNBs.

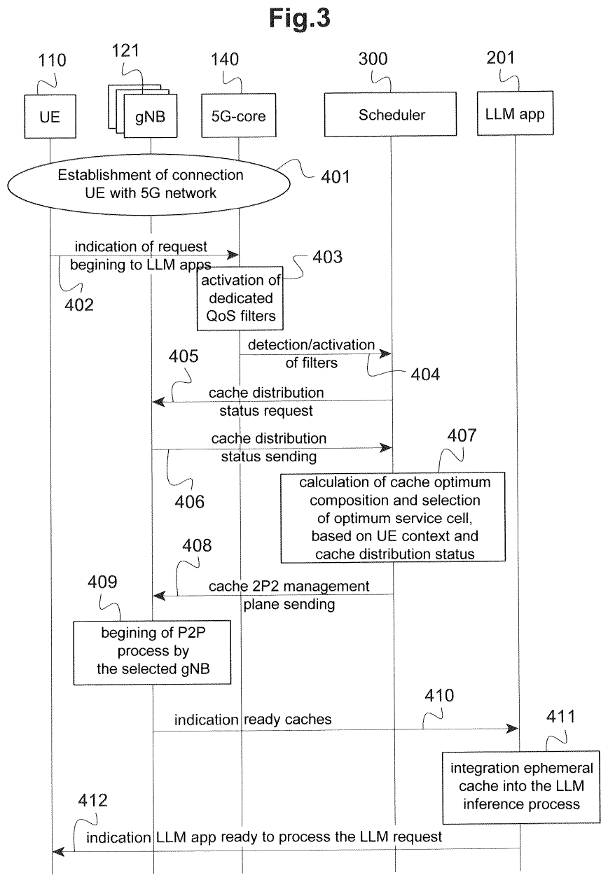

FIG. 3 is a flow diagram illustrating the initiation of the KV caches management process according to the invention.

After the UE 110 has established, in 401, a connection to the 5G network by creating a session using AMF/SMF functions 141/142 of the control plane 140, the UE indicates, in 402, to the control plane that it wishes to access one or more LLM applications, by sending corresponding LLM requests.

IN 403, the control plane determines the applicable QoS metrics (on the one hand, 5G network operational metrics, and on the other hand, user-specific metrics), and sends, in 404, to the scheduler 300 a QoS filter detection/activation signalling.

The scheduler 300 then sends, in 405, to the various gNB 121, a query request intended to establish the status of KV cache distribution within the radio access network 120.

The KV cache distribution status is sent, in 406, from the radio access network 120 to the scheduler 300, via the control plane 140.

In 407, the scheduler 300 calculates the optimum composition of the KV caches and selects the optimum cell to serve the requesting UE, as a function of various context parameters of the UEs and the current status of the KV cache distribution.

The resulting KV cache management plane is addressed, in 408, to the various gNB 121 of the radio access network 120, which launches, in 409, a P2P process between the gNBs selected by this management plane.

Once the P2P process completed, a message indicating that the KV caches are ready is sent, in 410, to the remote server hosting the LLM applications 201 to which the requests the users will issue are addressed.

In 411, the LLM application integrates in the inference process the parameters of the ephemeral KV cache within the access network, for example as an addressing to find the gNB where a memory location has been reserved for this KV cache.

The LLM application inference process is then ready to be executed, which is signalled to the UE, in 412, so that it can begin to send the LLM request tokens.

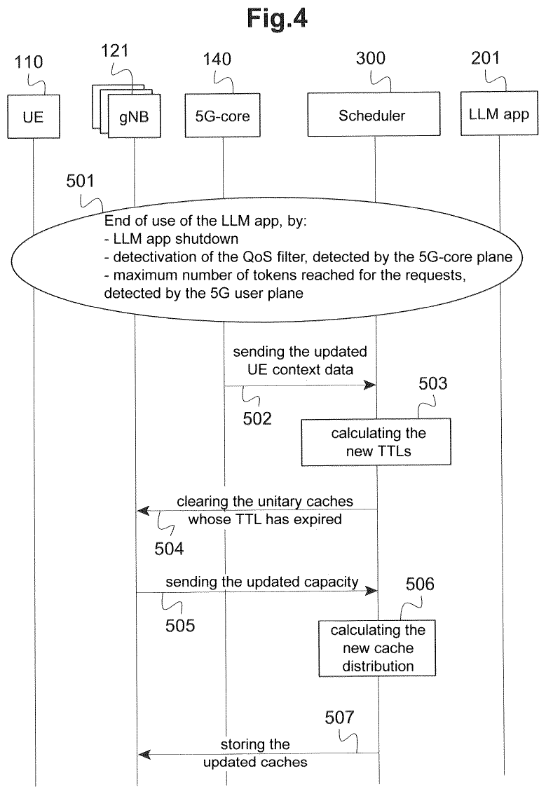

FIG. 4 is a flow diagram illustrating the completion of the KV caches management process according to the invention, with updating of the KV cache distribution within the network.

This completion may occur in a number of situations, including: LLM application shutdown, QoS filter deactivation detected by the control plane 140, or also maximum token number reached for the requests issued by this user, detected at the user plane 130.

The event is signalled in 501 to the different elements involved in the network, following which the control plane 140 addresses, in 502, to the scheduler 300, the contextual data updated to reflect this new situation.

The scheduler 300 calculates, in 503, the new values of the lifetimes TTL, so as to clear the KV caches whose TTL has expired, operation that is triggered by a message sent, in 504, to the active gNBs 121 of the radio access network 120.

The new storage capacity of the KV caches in the gNBs is then calculated at the radio access network 120 by a P2P process, and the result is sent, in 505, to the scheduler 300.

Finally, the scheduler calculates, in 506, the new KV cache distribution within the network and transmits, in 507, the status corresponding to the different gNB of the access network 120.

1. A mobile network architecture, for processing requests based on Large Language Models, LLMs, issued to LLM applications by users,
wherein the architecture comprises a 5G network with:
a radio access network, for radiofrequency communication with user equipments, UEs, the UEs accessing the network via 5G access nodes according to 3GPP, gNBs, including far-edge server calculation and storage resources;
a distributed network of programmable user plane functions, UPFs, also acting as a 5G data transport plane for routing data packets towards/from the UEs; and
a core network control plane comprising 5G functions according to 3GPP,
wherein, for processing LLM requests, the LLM applications implement multi-layer regressive inference processes using key-value caches allocated to respective UEs, and wherein:
the calculation and storage resources of the gNBs are configured to form a peer-to-peer network implementing key-value caches distributed within the 5G network, adapted to store the LLM requests from the UEs, wherein the gNBs serve the respective UEs;
the key-value caches are ephemeral caches with a limited lifetime;
the architecture further comprises a cache scheduler adapted to interact, on the one hand, with the LLM applications and, on the other hand, with the gNBs via the core network control plane; and
the cache scheduler comprises means adapted to create the key-value caches, assign the created key-value caches to the respective UEs, determine the lifetime of the key-value caches created, and update the key-value caches.

2. The mobile network architecture of claim 1, wherein the cache scheduler is adapted to establish a concatenation scheme for a plurality of existing key-value caches into a single merged key-value cache, allocated to a plurality of UEs.

3. The mobile network architecture of claim 2, further comprising point-to-point, P2P, communication means between gNBs to execute within the radio access network a concatenation of the plurality of existing key-value caches into a single merged key-value cache, according to a concatenation scheme established by the cache scheduler.

4. The mobile network architecture of claim 2, wherein the cache scheduler is adapted, previously to the merging of the plurality of key-value caches, to determine, among a plurality of gNBs of the radio access network, a gNB determined as being optimum based on latency, capacity and/or bandwidth constraints, and to store the merged key-value cache at the so-determined gNB.

5. The mobile network architecture of claim 2, wherein the cache scheduler is adapted, after completion of the LLM request processing and in the absence of subsequent LLM request, to suppress the merged key-value cache, assign unitary key-value caches to the UEs of the merged cache, and determine respective lifetimes for each of these unitary key-value caches.

6. The mobile network architecture of claim 5, wherein the lifetime of each key-value cache is a lifetime calculated at the creation of the key-value cache by the cache scheduler based on metrics determined by the 5G network.

7. The mobile network architecture of claim 6, wherein the cache scheduler is adapted to automatically clear the key-value caches after expiry of the limited lifetime.

8. The mobile network architecture of claim 6, wherein the cache scheduler is adapted to assign an increased lifetime to the most frequently accessed key-value caches.

9. The mobile network architecture of claim 6, wherein the lifetime calculation metrics include 5G network operational metrics, comprising:
rate of use of the gNB;
storage capacity available in the gNBs;
distribution/allocation of the network resources between uplink and downlink;
latency;
bandwidth; and/or
maximum number of tokens per second.

10. The mobile network architecture of claim 6, wherein the lifetime calculation metrics include metrics specific to the key-value cache user, comprising:
frequency of use of the LLM applications by the user;
belonging of the user to a predefined domain gathering a plurality of users;
privilege level assigned to user;
QoS degree guaranteed to the user; and/or
subscription by the user to LLM inference services.

11. The mobile network architecture of claim 6, wherein the lifetime calculation metrics include metrics of similarity between simultaneous users of the key-value caches, comprising:
belonging or not to a same predefined domain grouping a plurality of users; and/or
identical or close geographic location of the users.

12. The mobile network architecture of claim 6, further comprising point-to-point communication means between gNBs for a direct exchange of information relating to the lifetime calculation metrics.

13. The mobile network architecture of claim 1, wherein the UEs are devices of the group comprising smartphones, autonomous robots, and/or video surveillance cameras, including a circuit for connection to the 5G network and whose profile has already been entered into a 5G-network core network user database.
